(19) United States
(12) Patent Application Publication
(10) Pub. No.: US 2025/0265165 A1
(43) Pub. Date: Aug. 21, 2025

(54) Method And Apparatus For Detecting Bus Access State In Integrated Circuit, Medium, And Device

(71) Applicant: XG Tech PTE. LTD., Singapore (SG)

(72) Inventors: Panwen HAN, Singapore (SG); Tao LIU, Singapore (SG); Xiaofeng YAN, Singapore (SG)

(73) Assignee: XG Tech PTE. LTD., Singapore (SG)

(21) Appl. No.: 19/187,993

(22) Filed: Apr. 23, 2025

(30) Foreign Application Priority Data
Oct. 29, 2024 (CN) 202411524550.3

(51) Int. Cl. G06F 11/30; G06F 16/901

(52) U.S. Cl. CPC G06F 11/3055; G06F 16/9024

(57) ABSTRACT

The embodiments of the present disclosure disclose a method and apparatus for detecting a bus access state in an integrated circuit, medium, and a device, where the method includes: detecting first commands transmitted by a first channel of the bus in the integrated circuit; accumulating, by a first counter, a number of the first commands to obtain a first accumulated value; counting, based on the first accumulated value, a time-out duration for the first commands accumulated in the first counter by a second counter to obtain a second accumulated value; and determining, based on a relationship between the second accumulated value and a preset threshold, the access state of the bus.

### CROSS-REFERENCE TO RELATED APPLICATION

This application claims priority to Chinese Patent Application No. 202411524550.3, filed on Oct. 29, 2024, the entire disclosure of which is incorporated herein by reference.

### FIELD

The present disclosure relates to the field of data interaction technology, and more particularly, to a method and apparatus for detecting a bus access state in an integrated circuit, medium, and a device.

### BACKGROUND

In a chip system (e.g., System on Chip (SoC)) and an Application Specific Integrated Circuit (ASIC) etc., there are a variety of SoC bus transmission protocols that share a common feature of using handshaking signals between Master and Slave devices for proper data transmission. Most of the bus transmissions can be divided into two parts, namely a command transmission handshake phase and a data transmission handshake phase.

Once the handshake signal of the Slave is not properly sent out, the bus will be hung. When the bus is hung, the chip system will have a serious problem, such as crash.

### SUMMARY

In order to solve the above technical problem, the present disclosure has been proposed. The embodiments of the present disclosure provide a method and apparatus for detecting a bus access state in an integrated circuit, medium, and a device.

According to one aspect of the embodiment of the present disclosure, a method for detecting an access state of a bus (also referred to “a bus access state”) in an integrated circuit is provided, which includes:
detecting a plurality of first commands transmitted by a first channel of the bus in the integrated circuit;
accumulating, by a first counter, a number of the plurality of the first commands to obtain a first accumulated value;
counting, based on the first accumulated value, a time-out duration for the first commands accumulated in the first counter by a second counter to obtain a second accumulated value; and
determining, based on a relationship between the second accumulated value and a preset threshold, the access state of the bus.

According to another aspect of the embodiment of the present disclosure, an apparatus for detecting an access state of a bus in an integrated circuit is provided, which includes:
a command detection module configured to detect a plurality of first commands transmitted by a first channel of the bus in the integrated circuit;
a first counter configured to accumulate a number of the plurality of the first commands detected by the command detection module to obtain a first accumulated value;
a second counter configured to count, based on the first accumulated value obtained by the first counter, a time-out duration for the first commands accumulated in the first counter to obtain a second accumulated value; and
a state determination module configured to determine, based on a relationship between the second accumulated value determined by the second counter and a preset threshold, the access state of the bus.

According to yet another aspect of the embodiment of the present disclosure, a computer-readable storage medium is provided, which stores a computer program for performing the method for detecting an access state of a bus in an integrated circuit according to any of the embodiments described above.

According to yet another aspect of an embodiment of the present disclosure, an electronic device is provided, which includes:
a processor;
a memory for storing the processor-executable instructions;
wherein the processor is configured to read the executable instructions from the memory and execute the instructions to implement the method for detecting an access state of a bus in an integrated circuit according to any of the embodiments described above.

Based on the method and apparatus for detecting a bus access state in an integrated circuit, the medium, and the device provided by the above-mentioned embodiments of the present disclosure, the number of the first commands transmitted in the first channel of the bus with being uncompleted can be determined by accumulating the number of the first commands transmitted in the first channel by the first counter; in a case where the first accumulated value is not zero, it is indicated that there is the uncompleted first command in the first channel, and at this time, a time-out duration for the uncompleted first command may be counted by the second counter to obtain a second accumulated value indicating a duration of transmission of the first commands in the first channel; by comparing the relationship between the second accumulated value and the preset threshold, it can be determined whether the length of time that the bus is occupied by the first commands exceeds the preset threshold to determine the access state of the bus, thus realizing the detection of a case where the first channel of the bus is occupied, thereby detecting the problem of bus occupation time-out in time, reducing the serious problems such as crash in the chip system, and improving the transmission performance of the chip system greatly.

The embodiments of the present disclosure are described in further detail below with reference to the accompanying drawings and examples.

### BRIEF DESCRIPTION OF DRAWINGS

The above and other objectives, features and advantages of the present disclosure will become more apparent by describing embodiments of the present disclosure in detail in combination with the accompanying drawings. The accompanying drawings, which are included to provide a further understanding of the embodiments of the present disclosure and constitute a part of this specification, illustrate the present disclosure together with the embodiments of the present disclosure without limiting the present disclosure. In the drawings, like reference numerals generally refer to like parts or steps.

FIG. 1 is a schematic flow diagram illustrating a method for detecting a bus access state in an integrated circuit according to an example embodiment of the present disclosure;

FIG. 2 is a schematic flow diagram illustrating time-out counting in a method for detecting a bus access state in an integrated circuit according to another example embodiment of the present disclosure;

FIG. 3 is a schematic flow diagram illustrating command accumulation in a method for detecting a bus access state in an integrated circuit according to yet another example embodiment of the present disclosure;

FIG. 4 is a schematic flow diagram illustrating time-out counting in a method for detecting a bus access state in an integrated circuit according to yet still another example embodiment of the present disclosure;

FIG. 5 is a schematic flow diagram illustrating time-out counting in a method for detecting a bus access state in an integrated circuit according to still further another example embodiment of the present disclosure;

FIG. 6 is a schematic structural diagram illustrating an apparatus for detecting a bus access state in an integrated circuit according to an example embodiment of the present disclosure;

FIG. 7 is a schematic structural diagram illustrating an apparatus for detecting a bus access state in an integrated circuit according to another example embodiment of the present disclosure;

FIG. 8 is a schematic structural diagram illustrating an apparatus for detecting a bus access state in an integrated circuit according to yet another example embodiment of the present disclosure;

FIG. 9 is a schematic structural diagram illustrating an apparatus for detecting a bus access state in an integrated circuit according to yet still another example embodiment of the present disclosure;

FIG. 10 is a schematic structural diagram illustrating an apparatus for detecting a bus access state in an integrated circuit according to yet still another example embodiment of the present disclosure; and

FIG. 11 is a structural diagram showing an electronic device according to an example embodiment of the present disclosure.

### DETAILED DESCRIPTION

In order to explain the present disclosure, example embodiments of the present disclosure will be described in detail below with reference to the accompanying drawings. It is apparent that the described embodiments are merely a part of the embodiments of the present disclosure, rather than all of the embodiments. It should be understood that the present disclosure is not limited to the example embodiments described herein.

It should be noted that the relative arrangement of parts and steps, numerical expressions and numerical values set forth in these examples do not limit the scope of the present disclosure unless specifically stated otherwise.

### Application Overview

In implementing the present disclosure, it has been found by the inventor that bus hanging means that a command on the bus fails to normally release the bus for some reason during communication, causing the bus to be in a locked state and failing to perform normal data transmission. This often results in the entire chip system not being able to communicate with other devices on the bus, affecting proper operation of the chip system. In the prior art, the problem of bus hanging is not found timely enough, which may result in a long-time unavailability of the bus, resulting in a serious problem of performance degradation or even collapse of the chip system, etc.

### Examples of Method

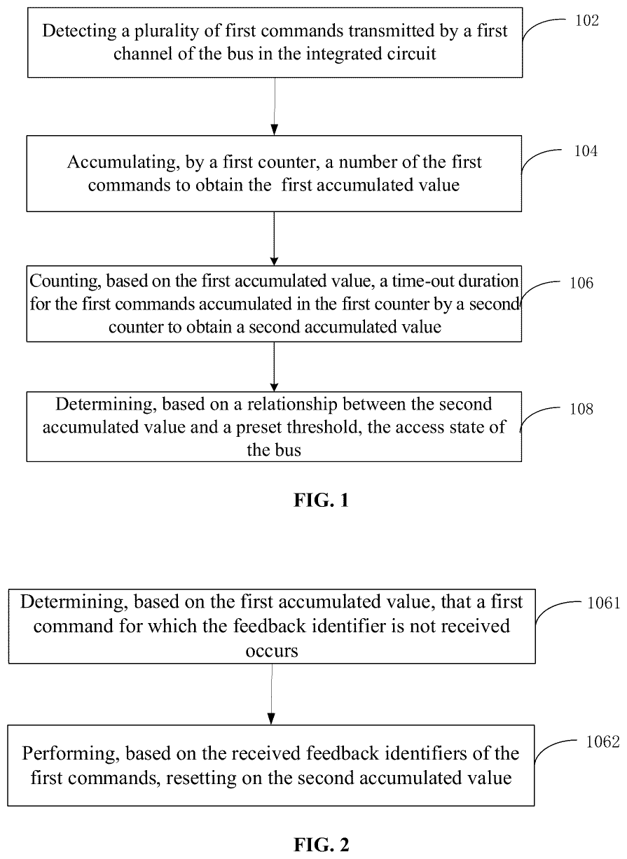

FIG. 1 is a schematic flow diagram illustrating a method for detecting a bus access state in an integrated circuit according to an example embodiment of the present disclosure. The present embodiment can be applied to an electronic device, as shown in FIG. 1, and includes the following steps:
step 102: detecting a plurality of first commands transmitted by a first channel of the bus in the integrated circuit.

Alternatively, the first channel may be any channel in the bus, for example, the first channel may be a Read Address Channel (abbreviated as an AR channel for transmitting address and control information for read requests), a Write Address Channel (abbreviated as an AW channel for transmitting address and control information for write requests) or a Snoop Address Channel (abbreviated as an AC channel for transmitting snooping transactions between caches in the system, allowing one cache master to snoop read and write operations on a particular memory address by other cache masters). The first command corresponds to a first channel, for example, the first channel is an AR channel, and the first command corresponding to the AR channel is a read command (an AR command); the first channel is the AW channel, and the first command corresponding to the AW channel is a write command (an AW command); the first channel is the AC channel, and the first command corresponding to the AC channel is a snooping command (an AC command).

Step 104: accumulating, by a first counter, a number of the plurality of the first commands to obtain a first accumulated value.

In one embodiment, the first accumulated value represents the number of the first commands transmitted in the first channel with being uncompleted, and a case where the first channel is occupied may be represented by the first accumulated value.

Step 106: counting, based on the first accumulated value, a time-out duration for the first commands accumulated in the first counter by a second counter to obtain a second accumulated value.

According to the embodiment of the present disclosure, if the first accumulated value is not zero, a time-out duration for at least one first command accumulated in the first counter is counted; and if the first accumulated value is zero, it is indicated that there is no first command for which the time-out duration needs to be accumulated, and the second accumulated value is zero.

In an alternative embodiment, the at least one first command in the first counter is indistinguishable, the time-out duration of the at least one first command in the first counter is counted via a second accumulated value, resetting the second accumulated value and decrementing the first accumulated value when any feedback identifier corresponding to the first command is received, and the counting of the time-out duration is restarted in a case where the first accumulated value is not zero. In another alternative embodiment, each first command in the first counter is distinguished, the time-out duration of the first command received first in the time sequence in the first counter is counted via the second accumulated value, and when the feedback identifier corresponding to the first command received first is received, the second accumulated value is reset, and the first accumulated value is decremented, and in a case where the first accumulated value is not zero, the counting of the time-out duration is restarted; however, in the present embodiment, when a feedback identifier corresponding to the other first command in the first counter is received, the second accumulated value is not reset, but the first accumulated value is decremented.

Step 108: determining, based on a relationship between the second accumulated value and a preset threshold, the access state of the bus.

In the present embodiment, the preset threshold can be configured according to a specific application scenario, and the configured preset threshold can be stored in a register to facilitate reading.

Alternatively, if the second accumulated value is greater than or equal to the preset threshold, it is determined that the access state of the bus is a hanging state, and access hanging information is sent out.

In the present embodiment, the hanging state refers to a state in which a first channel in a bus fails to operate normally due to being occupied by at least one first command, resulting in that other data, commands, etc. cannot be transmitted through the first channel, so that all devices communicating through the first channel cannot communicate. Alternatively, if the second accumulated value is smaller than the preset threshold, it is indicated that the access state of the bus is a normal state, i.e., the devices communicating via the first channel can communicate normally.

Alternatively, in the present embodiment, access hanging information is sent out by way of an interrupt, and alternatively, the access hanging information may be sent to an interrupt collection module (e.g., CPU, etc.). In the present embodiment, the interrupt-based reporting refers to a process in which a computer temporarily suspends execution of a current program when an exceptional situation (bus hanging) urgently needs to be handled or a request is sent out by an external device in the execution of the program, and the operation forwards to process these requests, and returns to a breakpoint of the original program again after completing processing to continue the execution. The interrupt mode is implemented by hardware, which allows the computer to respond to the external request in the process of executing the program, thereby improving parallelism of the system and the efficiency of CPU.

The above-mentioned embodiments of the present disclosure provide a method for detecting a bus access state in an integrated circuit, where the number of the first commands transmitted in the first channel of the bus with being uncompleted can be determined by accumulating the number of the first commands transmitted in the first channel by the first counter; in a case where the first accumulated value is not zero, it is indicated that uncompleted first command in the first channel occurs, and at this time, the second counter counts a time-out duration for the uncompleted first command, and the second accumulated value obtained by counting indicates a duration of transmission of the first command in the first channel; by comparing the relationship between the second accumulated value and the preset threshold, it can be determined whether the length of time that the bus is occupied by the first command exceeds the preset threshold to determine the access state of the bus, thus realizing the detection of a case where the first channel of the bus is occupied and detecting the problem of bus occupation time-out in time, thus reducing the serious problems such as crash in the chip system, and improving the transmission performance of the chip system greatly.

In some alternative embodiments, step 104 may include:
performing decrement processing on the first accumulated value based on received feedback identifiers corresponding to the first commands.

In the present embodiment, different types of first commands correspond to different feedback identifiers. In an alternative example, if the first channel through which the first command is transmitted is a read address channel, in the present embodiment, the corresponding feedback identifier is a rlast signal of the last stroke of read data (the read data represents the data returned according to the first command, and each first command may correspond to a plurality of strokes of read data) corresponding to any first command (a read command) received, and decrement processing is performed on the first accumulated value upon receiving the feedback identifier, i.e., after receiving the feedback identifier corresponding to any one of the at least one first command, it represents that the first command has been completed, and the first accumulated value representing the first number of accumulated first commands is decremented by one.

In another alternative example, if the first channel through which the first command is transmitted is a write address channel, in the present embodiment, the corresponding feedback identifier is a signal (e.g., a bvalid signal, it is indicated that a write response is valid) that represents that all data corresponding to any of the first commands (write commands) are received, and the decrement processing is performed on the first accumulated value upon receiving the feedback identifier.

In yet another alternative example, if the first channel through which the first command is transmitted is a snoop address channel, in the present embodiment, the corresponding feedback identifier is a response signal (e.g., a crvalid signal, it is indicated that a snoop response is valid) returned by a Snoop Response Channel (abbreviated as a CR channel), and decrement processing is performed on the first accumulated value upon receiving the feedback identifier.

As shown in FIG. 2, based on the above-mentioned embodiment shown in FIG. 1, step 106 may include the following steps:
step 1061: determining, based on the first accumulated value, that a first command for which the feedback identifier is not received occurs.

In the present embodiment, if the first accumulated value is zero, it is indicated that there is no uncompleted first command in the first channel, i.e., there is no first command to occupy the first channel, thus there is no need to perform the time-out counting, it can be understood that there is no second accumulated value or the second accumulated value is zero. If the first accumulated value is not zero, it is indicated that there is at least one first command occupying the first channel, i.e., there is at least one first command for which the feedback identifier is not received.

Step 1062: performing, based on the received feedback identifiers of the first commands, resetting on the second accumulated value.

In the present embodiment, when any one of the at least one first command corresponding to the first accumulated value receives the feedback identifier, it is indicated that the first channel is clear (information transmission can be performed) since the first channel can receive the feedback identifier, i.e., resetting is performed on the second accumulated value. After performing resetting on the second accumulated value, it is determined whether the first accumulated value is zero, and when the first accumulated value is not zero, timing is restarted based on the second counter, where the second accumulated value accumulated by timing represents the length of time that the first channel is occupied by the at least one first command corresponding to the first accumulated value.

According to the present embodiment, resetting is performed on the second accumulated value based on the feedback identifier, which improves the accuracy of the time-out duration expressed as the second accumulated value.

As shown in FIG. 3, based on the above-mentioned embodiment shown in FIG. 1, step 104 may include the following steps:
step 1041: saving, via a first linked list, at least one piece of relevant information corresponding to at least one first command in a time sequence of receiving the first commands.

Alternatively, the at least one piece of relevant information includes address information. Different first commands may correspond to different relevant information, for example, the relevant information corresponding to a read command and a write command includes, but is not limited to, command identification information (used for distinguishing different commands), command address information (used for storing an address of the first command), etc.; the relevant information corresponding to the snoop command includes, but is not limited to, command address information (for storing an address of the first command) and access type information (indicating an access type corresponding to the snoop command), etc. Alternatively, each first command corresponds to a piece of data in the first linked list, for example, the piece of data corresponding to the first command includes: command identifier: a1, command address information: 01011001, etc.; a piece of data corresponding to another first command includes: command identifier: a2, command address information: 01011011, etc.; the present embodiments are presented by way of illustration only and are not intended to limit the implementation of the embodiments of the present disclosure.

Alternatively, in some alternative examples, when the first command is a read command or a write command, the step 1041 may include:
for each of the detected first commands, allocating a first identifier to obtain at least one first identifier. The relevant information includes the first identifier

Alternatively, when one first identifier (ID) corresponds to a plurality of first commands, by sorting the plurality of first commands corresponding to the same first identifier in a time sequence, and also allocating the received feedback identifiers in the time sequence to the plurality of first commands corresponding to the first identifier, in-order processing for same-identifier (ID) transactions is achieved; time-out counting is individually performed for each first command through the added first identifier and the in-order processing of the same identifier, thereby improving the accuracy of the counting.

The step 1041 may further include: saving, via the first linked list, the at least one first identifier.

The present embodiment solves the problem of out-of-order of the feedback identifiers by allocating the corresponding first identifiers to the first commands, and when a feedback identifier is received, the first identifier is matched with the feedback identifier to determine which first command is completed, so as to ensure that the time-out counting is performed for the same command based on a second accumulated value, thereby improving the accuracy of the second accumulated value.

Step 1042: accumulating, by the first counter, the first commands corresponding to the relevant information saved in the first linked list to obtain the first accumulated value.

In the present embodiment, the received first commands are sorted according to a time sequence by adding the first linked list, and relevant information corresponding to each first command is stored in the first linked list to distinguish each first command; time-out counting is performed for each first command respectively based on the second accumulated value, instead of taking all the first commands as a whole, which improves the accuracy of the time-out duration represented by the second accumulated value; in addition, in the present embodiment, relevant information is stored through the first linked list, and a problem address can be quickly located according to the relevant information.

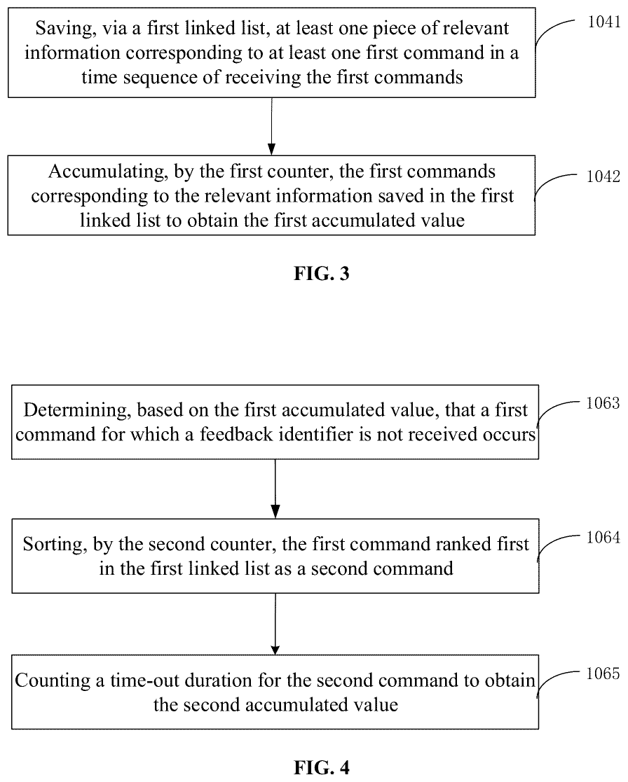

As shown in FIG. 4, based on the above-mentioned embodiment shown in FIG. 1, step 106 may include the following steps:
step 1063: determining, based on the first accumulated value, that a first command for which a feedback identifier is not received occurs.

Alternatively, it is determined whether the first accumulated value is zero, if the first accumulated value is zero, it is indicated that all the first commands have received the feedback identifiers, and if the first accumulated value is not zero, it is indicated that first command for which the feedback identifier has not been received occurs; that is, the present embodiment determines whether there are first commands requiring time-out counting based on the relationship between the first accumulated value and zero.

Step 1064: sorting, by the second counter, a first command ranked first in the first linked list as a second command.

Alternatively, in some examples, the time-out counting may be performed for each first command in the first linked list based on one second accumulated value, respectively; in this example, a corresponding second counter needs to be allocated for each first command to execute the time-out counting, which will lead to an increase in resource consumption while improving the accuracy of the time-out counting; in other examples, by time-out counting only the second command ranked first, the accuracy of the time-out counting is improved because the time-out counting is separately performed for the second command, and resource consumption is reduced because the time-out counting is performed for only one second command.

Step 1065: counting a time-out duration for the second command to obtain the second accumulated value.

In the present embodiment, by only using a second counter to count the time-out duration of the second command in the first linked list, accurate channel occupation statistics is achieved while reducing resource consumption; in addition, when the second command ranked first receives the feedback identifier, the data record corresponding to the second command is deleted in the first linked list, and resetting is performed on the second counter; in this case, the first command ranked first in the first linked list automatically becomes a new second command, and the second counter starts to count the time-out duration for the new second command, and so on, until the first command does not exist in the first linked list.

As shown in FIG. 5, based on the above-mentioned embodiment shown in FIG. 4, step 1065 may include the following steps:
step 501: detecting the feedback identifier transmitted by the first channel.

In the present embodiment, different first channels correspond to different feedback identifiers, for example, a first identifier corresponding to an AR channel is represented as an ARID, a feedback identifier corresponding to the AR channel is represented as an RID, and when the ARID and the RID match, a first command (or a second command) corresponding to the first identifier is deleted from a first linked list; a first identifier corresponding to an AW channel is represented as an AWID, and a feedback identifier corresponding to the AW channel is represented as a BID, and when the AWID and the BID match, the first command (or a second command) corresponding to the first identifier is deleted from the first linked list; a first identifier is not allocated to the AC channel, and matching is performed only on the feedback identifier according to the sorting in the first linked list to determine whether to delete the first command (or the second command) corresponding to the feedback identifier from the first linked list.

Step 502: performing, based on the first identifier corresponding to the feedback identifier, corresponding processing on the second accumulated value.

In the present embodiment, for a read address channel and a write address channel, each feedback identifier can search for a corresponding first identifier, and it is determined to perform resetting on the second accumulated value or continue accumulating processing on the second accumulated value based on the first identifier, and whether the feedback identifier corresponds to the second command can be determined by matching the first identifier; for the snoop address channel, since the first identifier does not exist, and the first commands are sorted in time sequence in the first linked list, in the present embodiment, the feedback identifier is matched with the second command ranked first in the first linked list for the AC channel, and corresponding processing (resetting) is performed on the second accumulated value.

Alternatively, a relationship between the first identifier corresponding to the feedback identifier and the first identifier corresponding to the second command is determined.

Alternatively, the above-mentioned relationship may include consistency or inconsistency, and different relationships correspond to different processes; for example, the relationship between the first identifier corresponding to the feedback identifier and the first identifier corresponding to the second command is consistent, it is indicated that the second command receives the feedback identifier, i.e., the accumulation of the time-out duration of this time can be ended.

The resetting or continuing accumulation is performed on the second accumulated value based on the above-mentioned relationship.

In the present embodiment, the second accumulated value only accumulates the time-out duration of the second command, and therefore, it is only necessary to compare the first identifier fed back with the first identifier corresponding to the second command to determine whether to perform resetting on the second accumulated value, thus simplifying the identifier comparison process and improving the identifier recognition efficiency.

The present embodiment improves the efficiency of matching the first command with the feedback identifier by allocating a corresponding identifier to a command, and since having an identifier enables identification of a corresponding first command among the plurality of first commands, it is not necessary to store each first command separately, and only one first linked list is required to store all the first commands, improving the storage efficiency, saving storage space and reducing resource occupation.

In some alternative embodiments, the resetting or continuing accumulation being performed on the second accumulated value based on the above-mentioned relationship includes:
if the relationship indicates that the first identifier corresponding to the feedback identifier is consistent with the first identifier corresponding to the second command, resetting is performed on the second accumulated value; and the next first command in the sorting of the first linked list is updated to a second command, and counting on the new second command is restarted; and
if the relationship indicates that the first identifier corresponding to the feedback identifier is inconsistent with the first identifier corresponding to the second command, determining a first command ranked first corresponding to the first identifier among the first commands in the first linked list as a third command, and deleting the third command from the first linked list.

In the present embodiment, when the above-mentioned relationship indicates inconsistency, it is indicated that the feedback identifier does not correspond to the second command, and in this case, resetting is not performed on the second accumulated value, and the second counter continues to perform time-out counting; furthermore, since one feedback identifier is received, the third command corresponding to the feedback identifier is deleted from the first linked list, and by determining of the third command, based on in-order processing for same-identifier (ID) transactions, when the first identifier corresponding to the feedback identifier corresponds to a plurality of first commands in the first linked list, the first command ranked first among the plurality of first commands is taken as the third command, which ensures that the first command ranked first in the first linked list is the first command received earlier, and realizes that the third command which has received the feedback identifier is correctly deleted from the first linked list, so that the first commands stored in the first linked list are all the first commands which have not received the feedback identifiers, thus improving the accuracy of the second accumulated value.

In some alternative embodiments, step 108 may include:
if the second accumulated value is greater than or equal to the preset threshold, determining that the access state of the bus is a hanging state, sending out access hanging information, and sending the at least one piece of relevant information.

In the present embodiment, at least one piece of relevant information is sent out while the access hanging information is sent out, which facilitates acquiring the hanging information, and a channel which is hung according to the relevant information and an address corresponding to the first command causing the hanging may be determined, thereby enabling appropriate handling of the hanging problem according to the interrupt reporting.

Any of the methods of detecting a bus access state in an integrated circuit provided by the embodiment of the present disclosure may be performed by any suitable device having data processing capabilities, including, but not limited to: a terminal device and a server, etc. Alternatively, the method for detecting a bus access state in any of the integrated circuits provided by the embodiment of the present disclosure may be executed by a processor, such as the processor executing the method for detecting a bus access state in any of the integrated circuits mentioned by the embodiment of the present disclosure by calling a corresponding instruction stored in a memory. It is not described hereafter in detail.

### Examples of Apparatus

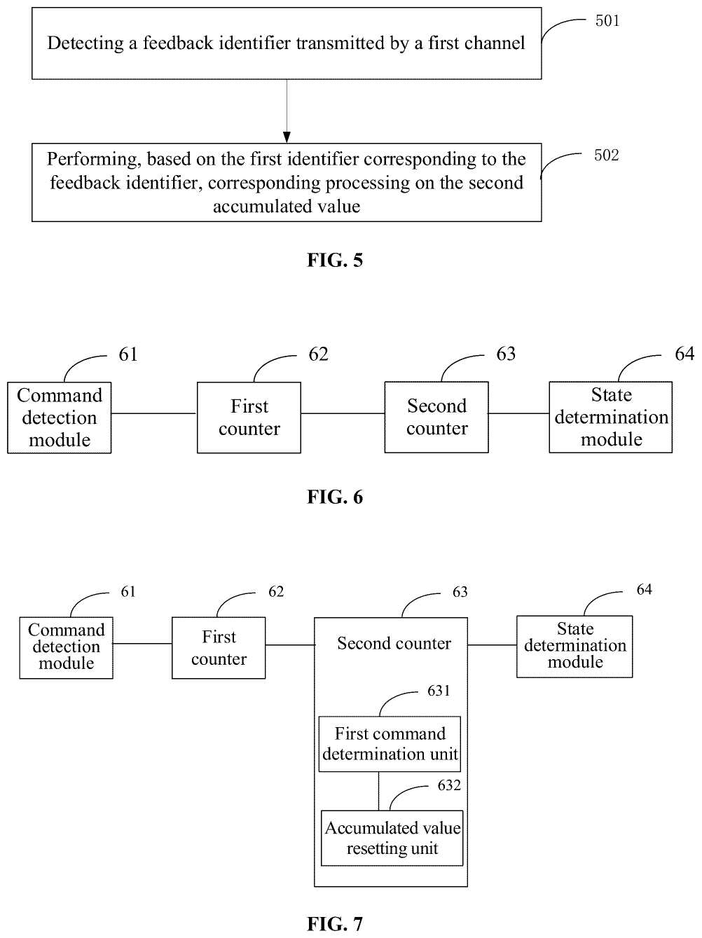

FIG. 6 is a schematic structural diagram illustrating an apparatus for detecting a bus access state in an integrated circuit according to an example embodiment of the present disclosure. The apparatus provided by the present embodiment can be integrated in one module (or chip) and the module is designed in a chip system. As shown in FIG. 6, the apparatus provided in the present embodiment may include:
a command detection module 61 configured to detect a plurality of first commands transmitted by a first channel of the bus in the integrated circuit.

A first counter 62 configured to accumulate a number of the plurality of the first commands detected by the command detection module 61 to obtain a first accumulated value.

A second counter 63 configured to, count, based on the first accumulated value obtained by the first counter 62, a time-out duration for the first commands accumulated in the first counter 62 to obtain a second accumulated value.

A state determination module 64 configured to determine, based on a relationship between the second accumulated value obtained by the second counter 63 and a preset threshold, the access state of the bus.

The above-mentioned embodiments of the present disclosure provide an apparatus for detecting a bus access state in an integrated circuit, where the number of the first commands transmitted in the first channel with being uncompleted of the bus can be determined by accumulating the number of the first commands transmitted in the first channel by the first counter; in a case where the first accumulated value is not zero, it is indicated that the uncompleted first command occurs in the first channel, and at this time, the second counter counts a time-out duration for the uncompleted first command, and the second accumulated value obtained by counting indicates a duration of transmission of the first command in the first channel; by comparing the relationship between the second accumulated value and the preset threshold, it can be determined whether the length of time that the bus is occupied by the first commands exceeds the preset threshold to determine the access state of the bus, thus realizing the detection of a case where the first channel of the bus is occupied, detecting the problem of bus occupation time-out in time, reducing the serious problems such as crash in the chip system, and improving the transmission performance of the chip system greatly.

Alternatively, the state determination module 64 is specifically configured to, if the second accumulated value is greater than or equal to the preset threshold, determine that the access state of the bus is a hanging state, and send out the access hanging information.

When the apparatus provided by the present embodiment is integrated in a separate chip in a chip system, the state determination module may be an external communication module through which the access hanging information is transmitted to an interrupt collection module.

Alternatively, the first counter 62 is specifically configured to perform, based on received feedback identifier corresponding to the first command, decrement processing on the first accumulated value.

FIG. 7 is a schematic structural diagram illustrating an apparatus for detecting a bus access state in an integrated circuit according to another example embodiment of the present disclosure. In the present embodiment, the second counter 63 includes:
a first command determination unit 631 configured to determine, based on the first accumulated value, that a first command for which the feedback identifier is not received occurs.

An accumulated value resetting unit 632 configured to perform, based on the received feedback identifier of the first command, resetting on the second accumulated value.

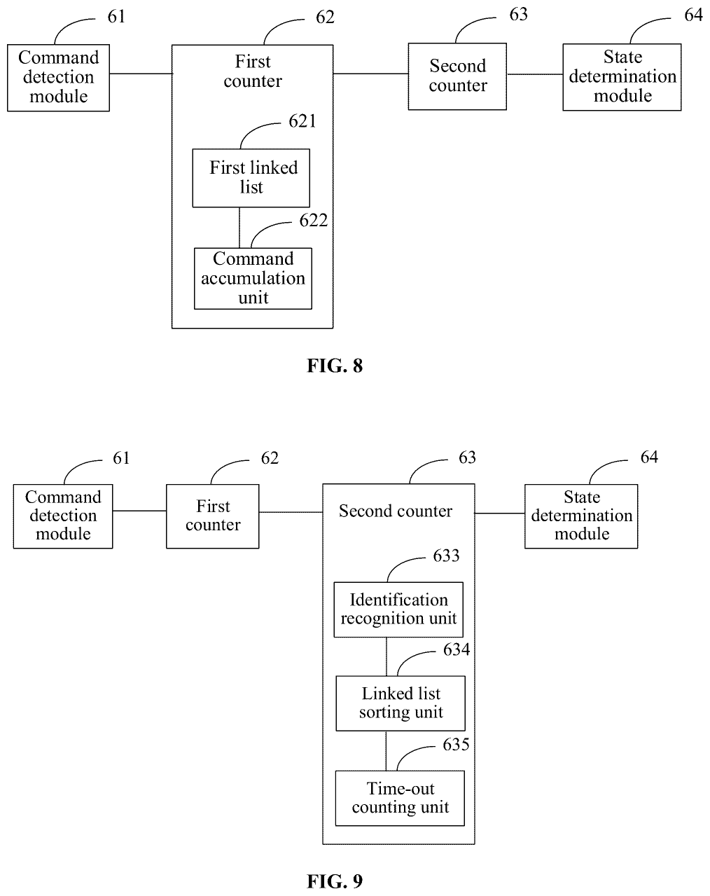

FIG. 8 is a schematic structural diagram illustrating an apparatus for detecting a bus access state in an integrated circuit according to yet another example embodiment of the present disclosure. As shown in FIG. 8, the first counter 62 in the present embodiment includes:
a first linked list 621 configured to save at least one piece of relevant information corresponding to the at least one first command in a time sequence of receiving the first commands.

A command accumulation unit 622 configured to accumulate the first commands corresponding to the relevant information saved in the first linked list to obtain the first accumulated value.

Alternatively, the first linked list 621 is specifically configured to allocate corresponding first identifier to the detected first command to obtain at least one of the first identifiers and save at least one first identifier, the relevant information including the first identifier

Alternatively, the at least one piece of relevant information includes address information.

For example, when the first linked list 621 corresponds to a read address channel, as shown in Table 1, the first column is a first identifier (ARID), the second column is address information (ARADDR), and an information storage format is schematically expressed in Table 1, in which a specific ID and address information are hidden, and the number of rows included in the first linked list in the present embodiment is not limited.

TABLE 1

| ARID | ARADDR |
|---|---|
| XXX | XXXXXX |
| XXX | XXXXXX |
| XXX | XXXXXX |

For example, when the first linked list 621 corresponds to a write address channel, as shown in Table 2, the first column is a first identifier (AWID), the second column is address information (AWADDR), and an information storage format is schematically expressed in Table 2, in which a specific ID and address information are hidden, and the number of rows included in the first linked list in the present embodiment is not limited.

TABLE 2

| AWID | AWADDR |
|---|---|
| XXX | XXXXXX |
| XXX | XXXXXX |
| XXX | XXXXXX |

For example, when the first linked list 621 corresponds to the snoop address channel, as shown in Table 3, the first column is address information (ACADDR) and the second column is access type information (ACSNOOP), and the information storage format is schematically expressed in Table 3, in which specific address information and access type information are hidden, and the number of rows included in the first linked list in the present embodiment is not limited.

TABLE 3

| ACADDR | ACSNOOP |
|---|---|
| XXX | XXXXXX |
| XXX | XXXXXX |
| XXX | XXXXXX |

FIG. 9 is a schematic structural diagram illustrating an apparatus for detecting a bus access state in an integrated circuit according to yet still another example embodiment of the present disclosure. As shown in FIG. 9, the second counter 63 in the present embodiment may include:
an identification recognition unit 633 configured to determine, based on the first accumulated value, that a first command for which the feedback identifier is not received occurs;
a linked list sorting unit 634 is configured to sort the first command ranked first in the first linked list as a second command; and
a time-out counting unit 635 configured to count a time-out duration for the second command to obtain the second accumulated value.

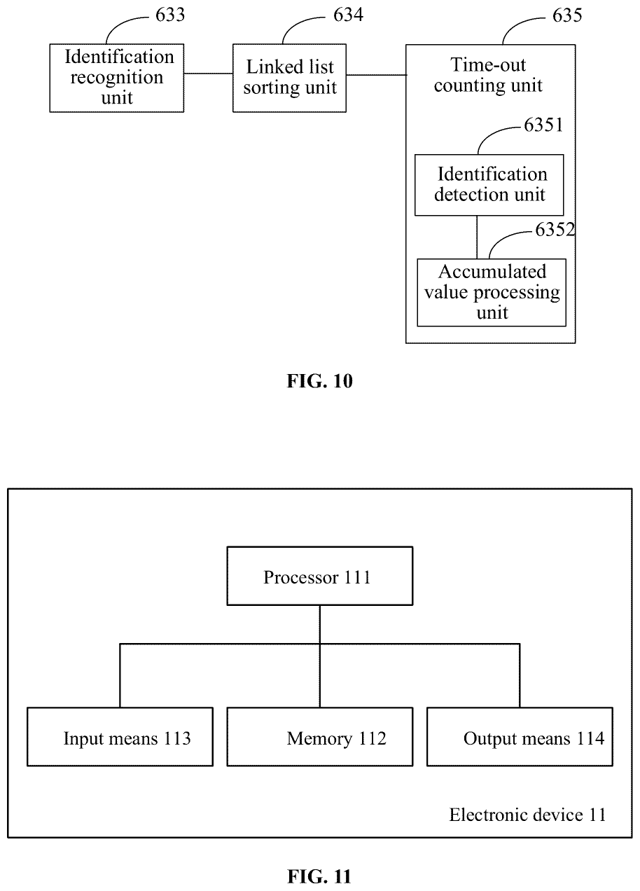

FIG. 10 is a schematic structural diagram illustrating an apparatus for detecting a bus access state in an integrated circuit according to yet still another example embodiment of the present disclosure. As shown in FIG. 10, the time-out counting unit 635 in the second counter 63 of the present embodiment may include:
an identification detection unit 6351 configured to detect a feedback identifier transmitted by a first channel.

An accumulated value processing unit 6352 configured to perform, based on the first identifier corresponding to the feedback identifier, corresponding processing on the second accumulated value.

Alternatively, the accumulated value processing unit 6352 is specifically configured to determine a relationship between the first identifier corresponding to the feedback identifier and the first identifier corresponding to the second command; perform resetting on the second accumulated value or continue the accumulation on the second accumulated value based on the relationship.

Alternatively, when the accumulated value processing unit 6352 performs resetting on the second accumulated value or continues to accumulate based on the relationship, the accumulated value processing unit is further configured to, if the relationship indicates that the first identifier corresponding to the feedback identifier is consistent with the first identifier corresponding to the second command, perform resetting on the second accumulated value; and if the relationship indicates that the first identifier corresponding to the feedback identifier is inconsistent with the first identifier corresponding to the second command, the first command ranked first among the first commands corresponding to the first identifiers in the first linked list is determined as a third command, and the third command is deleted from the first linked list.

Alternatively, the state determination module 64 is specifically configured to, if the second accumulated value is greater than or equal to the preset threshold, determine that the access state of the bus is a hanging state, send out the access hanging information, and send the at least one piece of relevant information.

Advantageous technical effects corresponding to example embodiments of the apparatus may be seen in the respective advantageous technical effects of the above section described above and will not be described in detail here.

### Example Electronic Device

FIG. 11 is a structural diagram showing an electronic device including at least one processor 111 and memory 112 according to an embodiment of the present disclosure.

The processor 111 may be a central processing unit (CPU) or other form of processing unit having data processing capabilities and/or instruction execution capabilities, and may control other components in the electronic device 11 to execute desired functions.

The storage 112 may include one or more computer program products, which may include various forms of computer-readable storage media, such as volatile memory and/or non-volatile memory. The volatile memory may for example include a random-access memory (RAM) and/or a cache memory (cache) etc. The non-volatile memory may include, for example, a read only memory (ROM), a hard disk, a flash memory, etc. One or more computer program instructions may be stored on a computer-readable storage medium, and the processor 11 may execute the one or more computer program instructions to implement the methods of detecting a bus access state in an integrated circuit and/or other desired functions of the various embodiments of the present disclosure as described above.

In one example, the electronic device 11 may further include: an input means 113 and an output means 114, which are interconnected by a bus system and/or other form of connection mechanism (not shown).

The input means 113 may include, for example, a keyboard, a mouse, etc.

The output means 114 may output various information to the outside, which may include, for example, a display, a speaker, a printer, and a communication network and its connected remote output devices, etc.

Of course, for simplicity, only some of the components of the electronic device 11 relevant to the present disclosure are shown in FIG. 11, omitting components such as buses, input/output interfaces, etc. In addition to this, the electronic device 11 may include any other suitable components depending on the particular application.

### Example Computer Program Product and Computer-Readable Storage Medium

In addition to the methods and devices described above, embodiments of the present disclosure may also provide a computer program product including computer program instructions which, when executed by a processor, cause the processor to perform the steps in the method for detecting a bus access state in an integrated circuit of the various embodiments of the present disclosure described in the “Example Methods” above.

The computer program product may include program code for executing operations for embodiments of the present disclosure written in any combination of one or more programming languages, including an object-oriented programming language such as Java, C++ or the like and conventional procedural programming languages, such as the “C” programming language or similar programming languages. The program code may execute entirely on the user computing device, partially on the user device, as a stand-alone software package, partially on the user computing device, partially on a remote computing device, or entirely on the remote computing device or server.

In addition, the embodiments of the present disclosure may also be a computer-readable storage medium having stored thereon computer program instructions which, when executed by a processor, cause the processor to perform the steps in a method for detecting a bus access state in an integrated circuit of the various embodiments of the present disclosure as described in the “Example Methods” above.

The computer-readable storage medium may take any combination of one or more readable media. The readable medium may be a readable signal medium or a readable storage medium. The readable storage medium for example but not limited to, an electronic, magnetic, optical, electromagnetic, infrared, or semiconductor system, apparatus, or component, or a combination of any one of the foregoing. More specific examples (a non-exhaustive list) of the readable storage medium include: an electrical connection having one or more wires, a portable computer diskette, a hard disk, a Random-access Memory (RAM), a read-only memory (ROM), an Erasable Programmable Read-only Memory (EPROM or flash memory), an optical fiber, a portable Compact Disk Read-only Memory (CD-ROM), an optical storage component, a magnetic storage component, or any suitable combination thereof.

The general principles of the present disclosure have been described above in connection with specific embodiments, the advantages, advantages, effects, etc. set forth in the present disclosure are merely example and not limiting, and are not to be construed as necessarily referring to the various embodiments of the present disclosure. Furthermore, the particular details disclosed above are for purposes of illustration and description only and are not intended to be limiting, as the present disclosure is not limited to the particular details disclosed above.

It would be apparent to a person skilled in the art that various modifications and alterations to the present disclosure will be made without departing from the spirit and scope of the present application. Thus, in case the modifications and variations of the present application are fallen within the scope of the claims and their equivalents, it is intended that the modifications and variations are included in the present disclosure.

What is claimed is:

1. A method for detecting an access state of a bus in an integrated circuit, comprising:
detecting a plurality of first commands transmitted by a first channel of the bus in the integrated circuit;
accumulating, by a first counter, a number of the plurality of the first commands to obtain a first accumulated value;
counting, based on the first accumulated value, a time-out duration for the first commands accumulated in the first counter by a second counter to obtain a second accumulated value; and
determining, based on a relationship between the second accumulated value and a preset threshold, the access state of the bus.

2. The method according to claim 1, wherein the determining, based on a relationship between the second accumulated value and a preset threshold, the access state of the bus comprises:
if the second accumulated value is greater than or equal to the preset threshold, determining that the access state of the bus is a hanging state, and sending out access hanging information.

3. The method according to claim 1, wherein the accumulating, by a first counter, a number of the plurality of the first commands to obtain a first accumulated value comprises:
performing, based on received feedback identifiers corresponding to the first commands, decrement processing on the first accumulated value.

4. The method according to claim 1, wherein the counting, based on the first accumulated value, a time-out duration for the first commands accumulated in the first counter by a second counter to obtain a second accumulated value comprises:
determining, based on the first accumulated value, that a first command for which the feedback identifier is not received occurs; and
performing, based on the received feedback identifiers of the first commands, resetting on the second accumulated value.

5. The method according to claim 1, wherein the accumulating, by a first counter, a number of the plurality of the first commands to obtain a first accumulated value comprises:
saving, via a first linked list, at least one piece of relevant information corresponding to at least one first command in a time sequence of receiving the first commands; and
accumulating, by the first counter, the first commands corresponding to the relevant information saved in the first linked list to obtain the first accumulated value.

6. The method according to claim 5, wherein the saving, via a first linked list, at least one piece of relevant information corresponding to at least one first command in a time sequence of receiving the first commands comprises:
allocating a first identifier for each of the detected first commands to obtain at least one first identifier, wherein the relevant information comprises the first identifier, and
saving, via the first linked list, the at least one first identifier.

7. The method according to claim 6, wherein the counting, based on the first accumulated value, a time-out duration for the first commands accumulated in the first counter by a second counter to obtain a second accumulated value comprises:
determining, based on the first accumulated value, that a first command for which a feedback identifier is not received occurs; and
sorting, by the second counter, a first command ranked first in the first linked list as a second command; and
counting a time-out duration for the second command to obtain the second accumulated value.

8. The method according to claim 7, wherein the counting a time-out duration for the second command to obtain the second accumulated value comprises:
detecting the feedback identifier transmitted by the first channel; and
performing, based on the first identifier corresponding to the feedback identifier, corresponding processing on the second accumulated value.

9. The method according to claim 8, wherein the performing, based on the first identifier corresponding to the feedback identifier, corresponding processing on the second accumulated value comprises:
determining a relationship between the first identifier corresponding to the feedback identifier and the first identifier corresponding to the second command; and
performing, based on the relationship, resetting on the second accumulated value or continuing accumulation on the second accumulated value.

10. The method according to claim 9, wherein the performing, based on the relationship, resetting on the second accumulated value or continuing accumulation on the second accumulated value comprises:
if the relationship indicates that the first identifier corresponding to the feedback identifier is consistent with the first identifier corresponding to the second command, resetting the second accumulated value; and
if the relationship indicates that the first identifier corresponding to the feedback identifier is inconsistent with the first identifier corresponding to the second command, determining a first command ranked first among the first commands corresponding to the first identifier in the first linked list as a third command, and deleting the third command from the first linked list.

11. The method according to claim 5, wherein the at least one piece of relevant information comprises address information.

12. The method according to claim 5, wherein the determining, based on a relationship between the second accumulated value and a preset threshold, the access state of the bus comprises:
if the second accumulated value is greater than or equal to the preset threshold, determining that the access state of the bus is an access hanging state, sending out access hanging information, and sending the at least one piece of relevant information.

13. A computer-readable storage medium storing a computer program thereon, which, when executed by a processor, causes the processor to implement a method for detecting an access state of a bus in an integrated circuit, comprising:
detecting a plurality of first commands transmitted by a first channel of the bus in the integrated circuit;
accumulating, by a first counter, a number of the plurality of the first commands to obtain a first accumulated value;
counting, based on the first accumulated value, a time-out duration for the first commands accumulated in the first counter by a second counter to obtain a second accumulated value; and
determining, based on a relationship between the second accumulated value and a preset threshold, the access state of the bus.

14. An electronic device, comprising:
a processor;
a memory for storing the processor-executable instructions;
wherein the processor is configured to read the executable instructions from the memory and execute the instructions to implement a method for detecting an access state of a bus in an integrated circuit, comprising:
detecting a plurality of first commands transmitted by a first channel of the bus in the integrated circuit;
accumulating, by a first counter, a number of the plurality of the first commands to obtain a first accumulated value;
counting, based on the first accumulated value, a time-out duration for the first commands accumulated in the first counter by a second counter to obtain a second accumulated value; and
determining, based on a relationship between the second accumulated value and a preset threshold, the access state of the bus.

15. The electronic device according to claim 14, wherein the determining, based on a relationship between the second accumulated value and a preset threshold, the access state of the bus comprises:
if the second accumulated value is greater than or equal to the preset threshold, determining that the access state of the bus is a hanging state, and sending out access hanging information.

16. The electronic device according to claim 14, wherein the accumulating, by a first counter, a number of the plurality of the first commands to obtain a first accumulated value comprises:
performing, based on received feedback identifiers corresponding to the first commands, decrement processing on the first accumulated value.

17. The electronic device according to claim 14, wherein the counting, based on the first accumulated value, a time-out duration for the first commands accumulated in the first counter by a second counter to obtain a second accumulated value comprises:
determining, based on the first accumulated value, that a first command for which the feedback identifier is not received occurs; and
performing, based on the received feedback identifiers of the first commands, resetting on the second accumulated value.

18. The electronic device according to claim 14, wherein the accumulating, by a first counter, a number of the plurality of the first commands to obtain a first accumulated value comprises:
saving, via a first linked list, at least one piece of relevant information corresponding to at least one first command in a time sequence of receiving the first commands; and
accumulating, by the first counter, the first commands corresponding to the relevant information saved in the first linked list to obtain the first accumulated value.

19. The electronic device according to claim 18, wherein the saving, via a first linked list, at least one piece of relevant information corresponding to at least one first command in a time sequence of receiving the first commands comprises:
allocating a first identifier for each of the detected first commands to obtain at least one first identifier, wherein the relevant information comprises the first identifier, and
saving, via the first linked list, the at least one first identifier.

20. The electronic device according to claim 19, wherein the counting, based on the first accumulated value, a time-out duration for the first commands accumulated in the first counter by a second counter to obtain a second accumulated value comprises:
determining, based on the first accumulated value, that a first command for which a feedback identifier is not received occurs; and
sorting, by the second counter, a first command ranked first in the first linked list as a second command; and
counting a time-out duration for the second command to obtain the second accumulated value.
